(19) United States
(12) Patent Application Publication
(10) Pub. No.: US 2023/0291747 A1
(43) Pub. Date: Sep. 14, 2023

(54) METHOD OF SECURING A VOTING TRANSACTION

(71) Applicant: DUCKPOND TECHNOLOGIES, INC., BATON ROUGE, LA (US)

(72) Inventor: DARTANYON ANTWAUN WILLIAMS, BATON ROUGE, LA (US)

(73) Assignee: DUCKPOND TECHNOLOGIES, INC., BATON ROUGE, LA (US)

(21) Appl. No.: 17/939,424

(22) Filed: Sep. 7, 2022

Related U.S. Application Data
(63) Continuation-in-part of application No. PCT/US2021/021785, filed on Mar. 10, 2021.
Application No. PCT/US2021/021785 is a continuation of application No. PCT/US2021/021761, filed on Mar. 10, 2021.
(60) Provisional application No. 62/987,389, filed on Mar. 10, 2020.
(60) Provisional application No. 62/987,396, filed on Mar. 10, 2020.

(51) Int. Cl. H04L 9/40; G07C 13/00; G06F 21/60

(52) U.S. Cl. CPC H04L 63/123; G07C 13/00; H04L 63/0861; H04L 63/083; G06F 21/602

(57) ABSTRACT

In the specification and drawings a method of securing a voting transaction is described and shown that includes initiating a voting transaction; verifying the identity of a voter; generating a passcode by the voting system; transmitting the passcode from the voting system to the voter over the telecommunication network; entering the passcode into a voting station; making one or more voting selections by the voter; transmitting the one or more voting selections from the voting station to the voting system over the telecommunication network; transmitting the passcode from the voting station to the voting system over the telecommunication network; verifying the authenticity of the passcode by the voting system; and declining to include the one or more voting selections in a vote count unless the passcode transmitted to the voting system by the voting station is verified authentic.

### I. CROSS-REFERENCE TO RELATED APPLICATION

This application is a continuation of and claims benefit to U.S. PCT application PCT/US/2021/021761 which was filed on Mar. 10, 2021, and which claimed benefit to U.S. provisional patent application No. 62/987,396, filed on Mar. 10, 2020, both of which are hereby incorporated by reference in their entirety. This application is also a continuation-in-part of and claims benefit to U.S. PCT application PCT/US2021/021785 which was filed on Mar. 10, 2021, and which claimed benefit to U.S. provisional patent application No. 62/987,389, filed on Mar. 10, 2020, both of which are hereby incorporated by reference in their entirety.

### II. TECHNICAL FIELD

An embodiment of the invention is in the field of election and voting systems, and can include features to protect the integrity and security of elections.

### III. BACKGROUND

Election security and integrity has been and continues to be an important aspect of elections of all types. Efforts have been made to increase the security and integrity of elections.

### IV. BRIEF DISCLOSURE OF AN EMBODIMENT OF THE INVENTION

An embodiment of the invention can include initiating a voting transaction; verifying the identity of a voter; generating a passcode by the voting system; transmitting the passcode from the voting system to the voter over the telecommunication network; entering the passcode into a voting station; making one or more voting selections by the voter; transmitting the one or more voting selections from the voting station to the voting system over the telecommunication network; transmitting the passcode from the voting station to the voting system over the telecommunication network; verifying the authenticity of the passcode by the voting system; and declining to include the one or more voting selections in a vote count unless the passcode transmitted to the voting system by the voting station is verified authentic.

### V. BRIEF DESCRIPTION OF THE SEVERAL VIEWS OF THE DRAWINGS

FIG. 1 is a schematic showing the direction of the transfer of information in an embodiment described herein.

FIG. 2 is a flow chart showing the steps of an embodiment described herein.

### VI. DETAILED DESCRIPTION OF THE BEST MODE

As required, detailed embodiments of the present invention are disclosed herein. However, it is to be understood that the disclosed embodiments are merely exemplary of the invention, which can be embodied in various forms. As such, any feature(s) used in one embodiment can be used in another embodiment. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The terms “connected” and/or “coupled,” as used herein, are defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

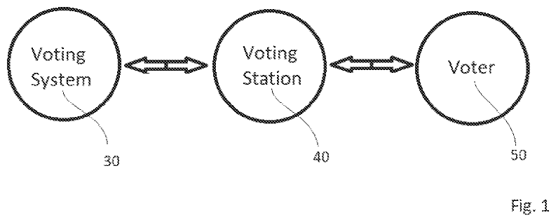

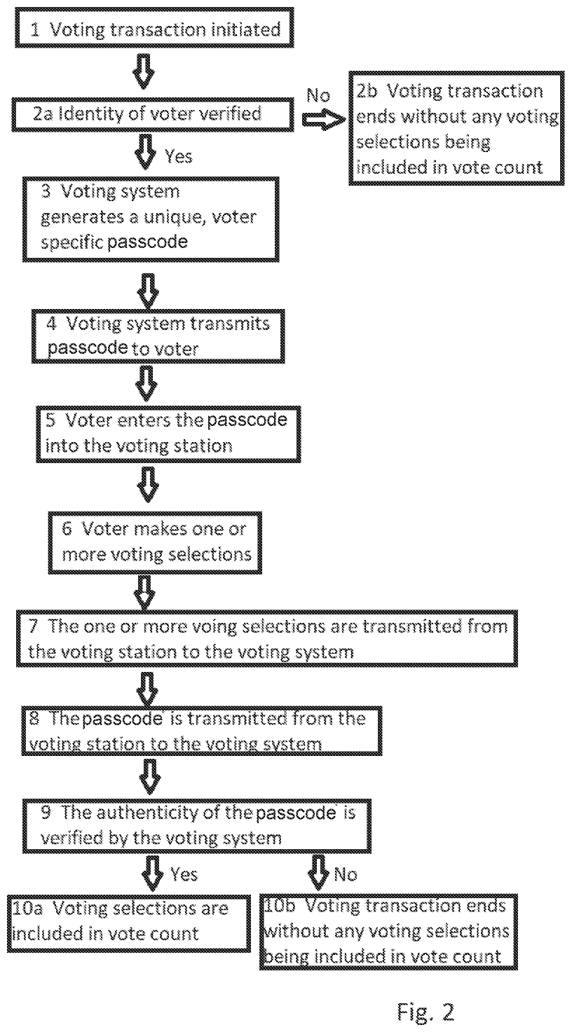

Described now are exemplary embodiments of the present invention. Referring now to the drawings, in FIGS. 1 and 2 an exemplary embodiment of a method of securing a voting transaction is shown and described.

In one embodiment, the disclosed system may be used to protect elections by securing voting transactions. In some embodiments, securing voting transactions can include features including, but not limited to verifying the identify of voters 50, verifying the authenticity of votes cast, encrypting voter information, voting selections, and other information, and minimizing or eliminating fraud. For example, in some embodiments the system may be used to secure a voter's 50 voting selections by encrypting a voter's 50 voting selections prior to transmitting the voting selections from a voting station 40 to the voting system 30. In an embodiment, the voting station can include computers, voting booths, mobile devices, apps, web pages, voting ballots, or other devices or platforms on which the voter 50 is capable of making a voting selection.

In various embodiments, the disclosed system may consist of or include a telecommunications network enabled to communicate with a voter's 50 mobile devices (e.g. cell phones, smart watches, tablets, computers, etc.), a database of voter information (e.g. name, address, voting precinct, etc.), and individual voting stations. In some embodiments, the database of voter information can include biometric data that can be used to verify the voter's identity by biometric identifiers such as iris recognition, facial recognition, voice recognition and fingerprint recognition.

In some embodiments, the system can require three out of four biometric identifiers to authenticate and verify the identity of the voter 50. In other embodiments, the system can require more or less than three out of four biometric identifiers to authenticate and verify the identity of the voter 50. In some embodiments, a pictorial identification (e.g. driver's license, passport, state ID, etc.) can be used as an additional method to authenticate and verify the identity of the voter 50. For example, a barcode on the back of a voter's 50 pictorial identification can be scanned by the voting station 40 (e.g. a voter's 50 mobile device) and transmitted over a telecommunications network to the voting system 30.

In the case of either biometric identifiers or pictorial identification, the voter's personal identifiable information (e.g. iris pattern, facial pattern, voice pattern, fingerprint, or pictorial identification information) can be maintained in a database, and can be compared to corresponding personal identifiable information provided by the voter 50 during or after the initiating of the voting transaction. In an embodiment, the database that maintains the voter's 50 personal identifiable information can be encrypted.

In some embodiments, the disclosed system may protect an election system by encrypting registered voter information. In various embodiments, the disclosed system may use blockchain technology to store encrypted information, where the system updates the blockchain, for example, every millisecond. In at least one embodiment, the disclosed system may send a passcode to a registered voter upon the registered voter's arrival and checking in at a voting site. In one embodiment, the disclosed system sends the passcode via text message, email, phone call, or other like communication methods, to the registered voter's mobile device.

In an embodiment, the passcode is a randomly generated number that is generated by the voting system 30, and is a unique passcode that is assigned only to a single voter 50. The passcode can be encrypted at various stages of the system, and the passcode can be unencrypted (e.g. prior to encryption or as a result of being decrypted) at various stages of the system. For example, the passcode can be encrypted (i.e. in an encrypted state) during the transmission of the passcode from the voting system 30 to the voter 50 over a telecommunication network. When the passcode reaches the voter, the passcode can be unencrypted, and the voter 50 can enter the passcode into the voting station 40. The voter 50 can then make one or more voting selections. The passcode can then be re-encrypted prior to transmitting the passcode back to the voting system 30 along with the voter's 50 voting selections, such that the passcode (and in some embodiments, the voting selections) is encrypted during the transmission of the passcode from the voting station 40 to the voting system 30.

In some embodiments, such as in some embodiments used in governmental elections, the voting system 30 does not store or otherwise retain any information that can be used to associate the voter 50 with any voting selections made by the voter 50. In other embodiments, such as in some embodiments where elections are held by businesses or other non-governmental entities, the voting system 30 may store and/or retain information that can be used to associate the voter 50 with the voting selections made by the voter 50.

In some embodiments, the voter's 50 mobile device receives the passcode and the voter enters the passcode into a voting station 40 before the voting station 40 authorizes the voter to make a voting selection (e.g. a selection in an election). In various embodiments, once the registered voter makes a selection in the election, the disclosed system may enter the voting selection onto one or more election blockchains, where a first blockchain may store only the voting selection, to be used for counting votes, and a second blockchain may store the registered voter's information and election selection.

In at least one embodiment, the disclosed system may authenticate the registered voter's voting selection by reading the information from the second blockchain, generating a communication that shows the voter's 50 voting selection, and sending the communication to the voter's 50 mobile device via text message, email, phone call, or other communication methods. In one embodiment, once the disclosed system receives the voting selection from the voter 50, the disclosed system may store information locally, wait for a specified period of time, then generate and send a communication to the voter's 50 mobile device, where the registered voter 50 can then confirm with the system that the voting selection is correct by sending a communication back to the voting system 30, where the system then enters the voter's 50 voting selection into the one or more blockchains.

In some embodiments, the voter 50 is able to capture and maintain a record of the voter's voting selection after the voter 50 has cast their vote(s). For example, in an embodiment, after the voter 50 has submitted their voting selections, an email, text message, or other communication can be generated by the voting system 30 and transmitted to the voter 50 that shows the voting selections that the voter 50 made, which can allow the voter 50 to verify the accuracy of the voter's 50 voting selections as recorded by the voting system 30. In an embodiment, the voter 50 can have the option of receive an encrypted copy of their marked ballot showing the voter's 50 voting selections. In some embodiments, the record of the voter's voting selections can be generated locally, such as at or by the voting station 40. In an embodiment, the voter 50 is able to print and keep a copy of their marked ballot showing the voter's 50 voting selections. In some embodiments, end-to-end voter verification can be accomplished, such that the voter 50 can check and verify that their voting selections are correct, and others are able to confirm that all ballots from all voters have been correctly recorded and counted.

In an embodiment, the system can be used to reduce or eliminate the potential for voter fraud. For example, in some embodiments, such as the embodiment discussed above where the registered voter confirms with the system that the election selection is correct by sending a communication back to the system, if the election selection is incorrect, the registered voter can send a communication back to the system that notifies the system that the election selection is incorrect. In such an event, the matter can be investigated to determine if voter fraud has occurred, or if instead it is a result of voter error or other issues. In some embodiments, an investigation is triggered even if only one voter reports that their election selection is incorrect. In other embodiments, an investigation is only triggered once a threshold number of voters have reported that their election selection is incorrect.

In other embodiments, there is no communication that is generated and sent to the voter 50 that shows the voter's 50 voting selection. Also, in some embodiments, the voter 50 is not provided with an opportunity to confirm with the system that the voting selection is correct by sending a communication back to the voting system 30.

In some embodiments, in addition to the voter 50 having the ability to print a copy of the voter's 50 marked ballot showing the voter's voting selections, the voting system 30 is also capable of printing a copy of some or all of the marked ballots in an election. By printing a copy of all marked ballots in an election, the voting system 30 is able to provide a printable audit trail of all voting selections made in an election, which can be used to verify the accuracy of vote counts, to allow for recounts, or for other purposes.

In an embodiment, the system can satisfy and accommodate any jurisdictional requirements, laws, or regulations as to ballot design, language, or election programming. For example, in some embodiments, the system can allow for multi-language support as may be required by applicable law. As another example, in some embodiments, the system can comply with the Americans with Disabilities act. The system can also allow for data import and export in a variety of formats (e.g. PDF, Excel, Text, etc.) in order to accommodate the varying formats that may be used across different jurisdictions and elections.

In operation of an embodiment, a method of securing a voting transaction can begin with the initiation of a voting transaction 1. For example, a voting transaction can be initiated 1 by detecting the arrival of a voter 50 at a voting station 40. Detecting the arrival of a voter 50 at a voting station 40 can be accomplished, for example, via one or more sensors scanning and recognizing biometric data of the voter 50, by using device-based location identification technology (e.g. the voter 50 carries devices such as RFID tags, mobile devices, etc. that is located by other devices), or by other means. In an embodiment, the voter can initiate the voting transaction 1 by checking in at the voting station 40, or by otherwise activating the voting station 40.

Next, the system attempts to verify the identity 2a of the voter 40. For example, the voting system 30 can maintain a database of voter information, which can include personally identifiable biometric information of the voter 50. The system can attempt to verify the identity 2a of the voter 50 by using the biometric data of the voter 50, such as by comparing voter biometric data provided by the voter 50 (e.g. biometric data provided by the voter during the initiation of the voting transaction 1) to the voter's 50 corresponding biometric data contained in the database of the voting system 30.

If the system is not able to verify the identity of the voter 50 (e.g. if the biometric data provided by the voter does not match the corresponding biometric data contained in the database of the voting system 30), the voting transaction ends without any of the voter's voting selections being included in the vote count of the election. If however the system is able to verify the identify of the voter 50, the voting transaction proceeds to the next step, in which the voting system 30 generates a random and unique passcode, which the voting system 30 then transmits 4 to the voter 50 over a telecommunications network (such as by sending the passcode over a telecommunications network to the voter's 50 mobile device).

Next, the voter 50 enters the passcode into the voting station 5. In some embodiments, this can result in the voting station 40 issuing (e.g. displaying) a ballot on which the voter 50 can make voting selections. The voter 50 can then proceed to make one or more voting selections 6. The voter 50 can then submit the ballot, which results in the transmission of the one or more voting selections from the voting station to the voting system 7 over a telecommunications network. Either separately or contemporaneously with the transmission of the one or more voting selections, the passcode can be transmitted from the voting station to the voting system over the telecommunications network 8. The authenticity of the passcode is then verified by the voting system 9, such as by the voting system 30 checking if the passcode transmitted to the voting system by the voting station 8 matches the passcode generated by the voting system.

If the voting system 30 fails to verify the authenticity of the passcode (e.g. if the passcode transmitted to the voting system 30 by the voting station 8 does not match the passcode generated by the voting system 30), the voting transaction ends without any voting selections being included in the vote count 10b. If however the passcode transmitted to the voting system 30 is verified by the voting system to be authentic 9, the one or more voting sections of the voter 40 are included in the vote count 10a.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention.

I claim:

1. A method of securing a voting transaction conducted, at least in part, over a telecommunication network among a voter, a voting station, and voting system, wherein the method comprises:
a) initiating a voting transaction;
b) verifying the identity of the voter;
c) generating a passcode by the voting system;
c) transmitting the passcode from the voting system to the voter over the telecommunication network;
d) entering the passcode into the voting station;
e) making one or more voting selections by the voter;
f) transmitting the one or more voting selections from the voting station to the voting system over the telecommunication network;
g) transmitting the passcode from the voting station to the voting system over the telecommunication network;
h) verifying the authenticity of the passcode by the voting system; and
i) declining to include the one or more voting selections in a vote count unless the passcode transmitted to the voting system by the voting station is verified authentic.

2. The method of securing a voting transaction of claim 1 wherein said initiating a voting transaction further comprises detecting the voter's arrival at a voting station.

3. The method of securing a voting transaction of claim 1 further comprising maintaining a database containing voter information.

4. The method of securing a voting transaction of claim 3 wherein said maintaining a database of voter information further comprises maintaining a database containing voter biometric data.

5. The method of securing a voting transaction of claim 4 wherein said verifying the identity of the voter further comprises verifying the identity of the voter using voter biometric data.

6. The method of securing a voting transaction of claim 5 wherein said verifying the identity of the voter using biometric data of the voter further comprises comparing the voter biometric data to the database of voter biometric data.

7. The method of securing a voting transaction of claim 6 further comprising storing the one or more voting selections in a blockchain without storing the voter information in the blockchain.

8. The method of securing a voting transaction of claim 6 further comprising storing the one or more voting selections in a blockchain and storing the voter information in the blockchain.

9. The method of securing a voting transaction of claim 6 further comprising:
a) storing the one or more voting selections in a first blockchain without storing the voter information in the first blockchain; and
b) storing the one or more voting selections in a second blockchain and storing the voter information in the second blockchain.

10. The method of securing a voting system of claim 9 further comprising using the one or more voting selections in the first blockchain to count votes in the vote count.

11. The method of securing a voting system of claim 9 further comprising using the one or more voting selections and the voter information in the second blockchain to confirm the one or more voting selections.

12. The method of securing a voting system of claim 11 wherein said using the one or more voting selections and the voter information in the second blockchain to confirm the one or more voting selections further comprises:
a) generating a message to the voter that shows the voter's one or more voting selections; and
b) transmitting a message from the voter to the voting system that confirms the one or more voting selections.

13. The method of securing a voting transaction of claim 1, wherein said verifying the authenticity of the passcode by the voting system further comprises checking if the passcode transmitted to the voting system by the voting station matches the passcode generated by the voting system.

14. The method of securing a voting transaction of claim 13, wherein said declining to include the vote in a vote count unless the passcode transmitted to the voting system by the voting station is verified authentic further comprises declining to include the vote in a vote count unless the passcode transmitted to the voting system by the voting station matches the passcode generated by the voting system.

15. The method of securing a voting transaction of claim 1 wherein the passcode is encrypted during said transmitting the passcode from the voting system to the voter over the telecommunication network.

16. The method of securing a voting transaction of claim 1 wherein the passcode is encrypted during said transmitting the passcode from the voting station to the voting system over the telecommunication network.

17. The method of securing a voting transaction of claim 1 wherein the one or more voting selections are encrypted during said transmitting the one or more voting selections from the voting station to the voting system over the telecommunication network.

18. The method of securing a voting transaction of claim 1 further comprising using blockchain technology to store encrypted information.

19. The method of securing a voting transaction of claim 1 further comprising creating an association between the one or more voting selections and the passcode, and maintaining the association between the one or more voting selections and the passcode during said:
a) transmitting the one or more voting selections to the voting system over the telecommunication network; and
b) transmitting the passcode to the voting system over the telecommunication network.

20. The method of securing a voting transaction of claim 1 wherein said initiating a voting transaction further comprises checking in at a voting station by a user.
